(19) United States
(12) Patent Application Publication
(10) Pub. No.: US 2009/0125485 A1
(43) Pub. Date: May 14, 2009

(54) System for Searching for Desired Music

(75) Inventor: Chi-Chen CHENG, Taipei City (TW)

Correspondence Address: TROXELL LAW OFFICE PLLC, 5205 LEESBURG PIKE, SUITE 1404, FALLS CHURCH, VA, 22041, US

(73) Assignee: iPeer Multimedia International Ltd, Taipei City (TW)

(21) Appl. No.: 12/239,765

(22) Filed: Sep. 27, 2008

(30) Foreign Application Priority Data
Nov. 8, 2007 (TW) 096218803

(51) Int. Cl. G06F 7/06; G06F 17/30

(52) U.S. Cl. 707/3; 707/E17.014

(57) ABSTRACT

Disclosed is a system for searching desired music. The system includes a remote control mechanism, a connector connected to the remote control mechanism and at least one search mechanism connected to the connector. The search mechanism includes a communication interface unit and a search unit connected to the communication interface unit. The search unit includes an algorithm element and a music database. The music database includes a plurality of music units.

### FIELD OF INVENTION

The present invention relates to a system for searching for desired music and, more particularly, to a system for efficiently and accurately searching for desired music based on the attributes of the desired music.

### BACKGROUND OF INVENTION

Computers are often connected to websites through the Internet so that multi-media data can be downloaded to the computers from the websites through the Internet. The multi-media data can be stored in and played by the computers. Alternatively, multi-media players can be connected to the computers so that the multi-media data can be stored in and played by the multi-media players.

However, when music is downloaded, only the titles of pieces of music and the formats of files corresponding to the pieces of music are included. Therefore, users have to rename the pieces of music. Based on personal rules, the users number the pieces of music, and enter the names of the singers or players of the pieces of music, the titles of the pieces of music and, if any, other data related to the pieces of music into the computers or the multi-media players. Hence, the users can later search for desired pieces of music based on the data that they enter into the computers or the multi-media players. However, the classified filing of the pieces of music is rough and all of the attributes of the pieces of music are not considered. If the computers or the multi-media players do not support the renaming of the pieces of music by the users, random codes are shown on the computers or the multi-medial players. In this case, the users have to play the pieces of music one after another to get the desired pieces of music. That is, the users cannot efficiently get the desired pieces of music, and this is inconvenient.

The present invention is therefore intended to obviate or at least alleviate the problems encountered in prior art.

### SUMMARY OF INVENTION

It is the primary objective of the present invention to provide a system for searching desired music.

To achieve the foregoing objective, the system includes a remote control mechanism, a connector connected to the remote control mechanism and at least one search mechanism connected to the connector. The search mechanism includes a communication interface unit and a search unit connected to the communication interface unit. The search unit includes an algorithm element and a music database. The music database includes a plurality of music units.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a partial view of a system for searching desired music according to the preferred embodiment of the present invention.

FIG. 2 is a block diagram of the system shown in FIG. 1 and a connector.

FIG. 3 is a detailed block diagram of the system shown in FIG. 2.

FIG. 4 is a block diagram of a note zone.

### DETAILED DESCRIPTION OF PREFERRED EMBODIMENT

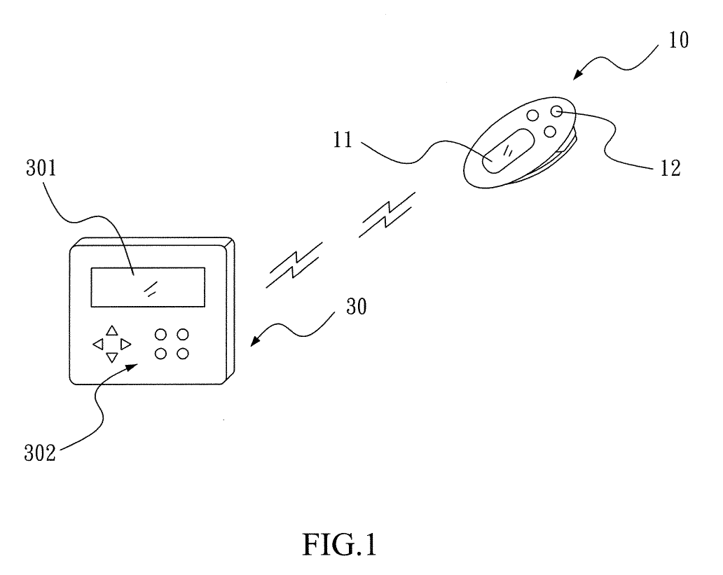

Referring to FIGS. 1 to 4, there is shown a system for searching for desired music according to the preferred embodiment of the present invention. The system includes a remote control mechanism 1, a connector 2 and at least one search mechanism 3. Pieces of music can be classified and filed with the system so that efficient and accurate searching for desired pieces of music is possible.

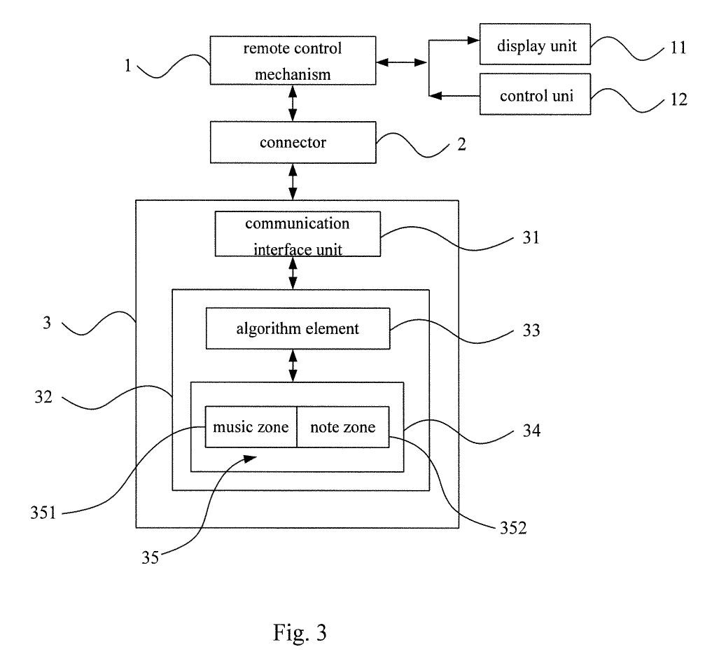

Referring to FIG. 3, the remote control mechanism 1 includes a display unit 11 and a control unit 12. The remote control mechanism 1 may be an earphone, a remote controller, a keyboard or an operative panel.

The connector 2 is connected to the remote control mechanism 1 through cables, a cable network, a wireless network or infrared communication or according to the Bluetooth communication protocol.

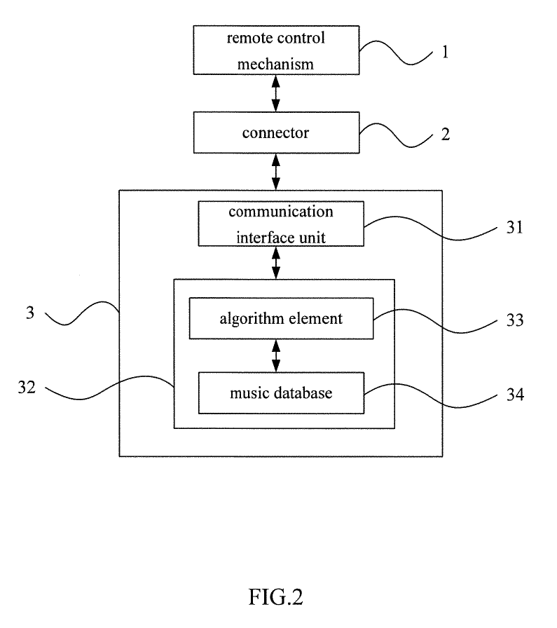

The search mechanism 3 is connected to the connector 2. The search mechanism 3 may be an MP3 player, a laser disc player, a laser disc recorder, a computer or any other proper devices. The search mechanism 3 includes a communication interface unit 31 and a search unit 32 connected to the communication interface unit 31. The search unit 32 includes an algorithm element 33 connected to the communication interface unit 31 and a music database 34 connected to the algorithm element 33. The music database 34 generally includes a plurality of music units 35 although only one is shown in FIG. 2. Each of the music units 35 includes a music zone 351 and a note zone 352.

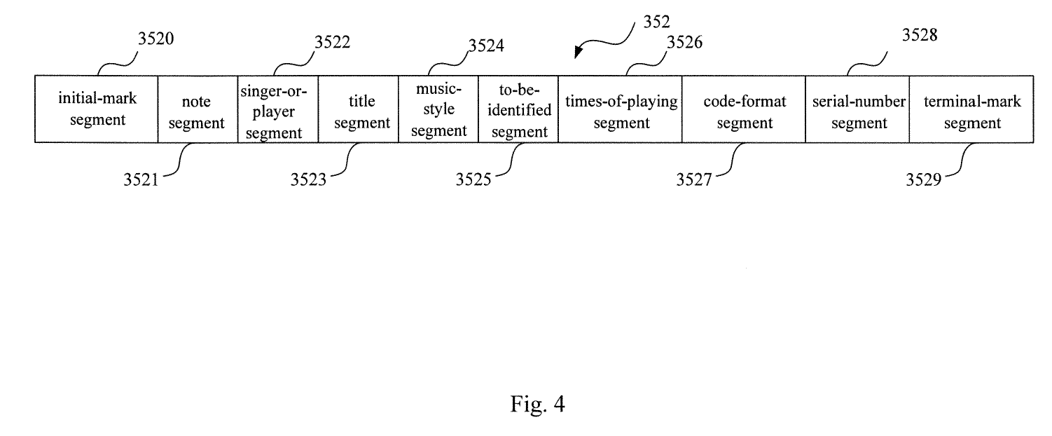

Referring to FIG. 4, the note zone 352 includes an initial-mark segment 3520, a note segment 3521, a singer-or-player segment 3522, a title segment 3523, a music-style segment 3524, a to-be-identified segment 3525, a times-of-playing segment 3526, a code-format segment 3527, a serial-number segment 3528 and a terminal-mark segment 3529.

The operation of the system will be described. The remote control mechanism is an earphone 10 for example. The search mechanism 3 is an MP3 player 30 for example. The MP3 player 30 includes a display unit 301 and a control unit 302.

In operation, a user uses the control unit 12 of the earphone 10 to enter keywords such as the name of a singer or player of a piece of music, the title of the piece of music, the music style of the piece of music and the language of the piece of music. The keywords are transferred to the algorithm element 33 of the search unit 32 through the communication interface unit 31. Based on the keywords, the algorithm element 33 searches the music database 34 for a desired piece of music. More particularly, the algorithm element 33 searches the note zone 352 of each music unit 35. The initial-mark segment 3520, the note segment 3521, the singer-or-player segment 3522, the title segment 3523, the music-style segment 3524, the to-be-identified segment 3525, the times-of-playing segment 3526, the code-format segment 3527, the serial-number segment 3528 and the terminal-mark segment 3529 of the note zone 352 of each music unit 35 are involved during the calculation with the algorithm element 33. Thus, a desired music unit 35 compliant with the keywords can be found. The display unit 11 of the earphone 10 shows the desired music unit 35. The user can use the control unit 12 of the earphone 10 to access to the music zone 351 of the desired music unit 35 for playing or processing.

As discussed above, the system enables the user to search for the desired piece of music based on the attributes of the desired piece of music efficiently and accurately.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A system for searching desired music comprising:
a remote control mechanism;
a connector connected to the remote control mechanism; and
at least one search mechanism connected to the connector, said search mechanism comprising:
a communication interface unit; and
a search unit connected to the communication interface unit and formed with an algorithm element and a music database comprising a plurality of music units.

2. The multi-medial system according to claim 1, wherein the remote control mechanism comprises a display unit and a control unit.

3. The multi-medial system according to claim 1, wherein the remote control mechanism is connected to the connector through cables.

4. The multi-medial system according to claim 1, wherein the remote control mechanism is connected to the connector through a cable network.

5. The multi-medial system according to claim 1, wherein the remote control mechanism is connected to the connector through a wireless network.

6. The multi-medial system according to claim 1, wherein the remote control mechanism is connected to the connector through infrared communication.

7. The multi-medial system according to claim 1, wherein the remote control mechanism is connected to the connector according to the Bluetooth communication protocol.

8. The multi-medial system according to claim 1, wherein the music unit comprises:
a music zone; and
a note zone comprising an initial-mark segment, a note segment, a singer-or-player segment, a title segment, a music-style segment, a to-be-identified segment, a times-of-playing segment, a code-format segment, a serial-number segment and a terminal-mark segment.
